(19) United States
(12) Patent Application Publication
(10) Pub. No.: US 2010/0299332 A1
(43) Pub. Date: Nov. 25, 2010

(54) METHOD AND SYSTEM OF INDEXING NUMERICAL DATA

(75) Inventors: Yves Dassas, London (GB); Jonathan Goldhill, London (GB)

Correspondence Address: KENYON & KENYON LLP, RIVERPARK TOWERS, SUITE 600, 333 W. SAN CARLOS ST., SAN JOSE, CA, 95110, US

(73) Assignee: ZANRAN LIMITED, London (GB)

(21) Appl. No.: 12/863,977

(22) PCT Filed: Feb. 6, 2009
(86) PCT No.: PCT/GB2009/000331

§ 371 Date: Aug. 5, 2010

(30) Foreign Application Priority Data
Feb. 7, 2008 (GB) 0802321.0

(51) Int. Cl. G06F 17/30

(52) U.S. Cl. 707/741; 707/E17.046

(57) ABSTRACT

The present invention provides a computer-implemented method for indexing numerical information embedded in one or more electronic files. The method comprises determining whether an electronic file comprises one or more images containing embedded numerical data, including the steps of inputting the one or more images into a classification system comprising a plurality of interconnected classifiers; and classifying the one or more images using the classification system to output data classifying each image. The output data classifies each image as one of: containing embedded numerical data or not containing embedded numerical data. The method further comprises analysing the file to output data classifying it as one of: containing tabulated numerical data or not containing tabulated numerical data. If the outputted data indicates that the file comprises one or more images with embedded numerical data and/or contains tabulated numerical data, and the method further comprises extracting text and/or other data associated with the numerical data and indexing this text and/or other data in a database.

The present invention is in the field of search engines and the indexing of electronic files stored across distributed networks. The present invention has particular applicability to a method of searching for content that contains embedded numerical data.

Distributed computer networks are becoming the standard means of storing a large amount of heterogeneous information. Typically, this information is provided by a large number of heterogeneous information providers. The Internet, in particular, allows a user to access a large number of electronic files that are distributed across numerous geographically-diverse computer networks that use the TCP/IP protocol.

To find a particular piece of information, a user may use a known search engine to search a collection of files stored across a distributed network. Such a search engine may be limited to a particular domain, such as an organisation's intranet, or may search the whole Internet. There are many search engines available to a user. Some well known examples are Google, Yahoo!, and MSN Live!. Most search engines operate according to a common method: the search engine will be directed to, or will follow a link to, a given HTML (HyperText Markup Language) file, wherein the search engine will scan the text making up the HTML file in order to extract relevant text and index the file. The indexing of the file typically comprises indexing the Uniform Resource Locator (URL) of the file against one or more keywords or phrases found within the text or HTML tags that comprise the HTML file. This index is commonly generated in one or more databases managed by the search engine provider and the routine is often automated using a plurality of automated routines or software “bots” known as “spiders” or “crawlers”. These “spiders” constantly follow links to different documents located upon the Internet in a process known as “crawling”. Once a complex index has been generated a user is then able to use an Internet browser to enter a number of keywords or phrases (a “search query”) into a text box provided by the search engine, and the search engine is able to execute a query upon the index to see whether there are any entries that match the input keywords or phrases. If matches exist then the appropriate URLs are returned to the user, typically in the form of a list ranked using proprietary algorithms. The user can then use their browser to access one or more electronic files stored at the returned URLs.

Whilst most search engines are highly successful at helping a user find relevant documents accessible on distributed networks such as the Internet, they are not perfect and suffer from a particular bias; a bias that is hidden from the user by the wealth of results a search engine returns. This bias is that known search engines are primarily designed to find and index text content. This can be clearly seen when performing an image search, the results of which typically display a mix of photographs, logos, and perhaps graphs. Common search engines may ignore or incorrectly index documents or files that are not primarily text-based. This then generates a problem for users wishing to find files or documents that contain non-text data, such as embedded numerical data.

EP1835423 discloses the identification, extraction, linking, storage and provisioning of data that constitute the captioned components of published literature for search and data mining.

U.S. Pat. No. 6,996,268 B2 teaches a method of indexing images in order to broaden searches over the Internet. However, this method suffers from accuracy problems and is restricted to classifying images. “NPIC: Hierarchical Synthetic Image Classification Using Search and Generic Features” by Fei Wang and Min-Yen Kan (Dept. of Computer Science, University of Singapore) teaches a method of image classification that may be used to classify synthetic images. However, this method also suffers from accuracy problems and lacks wider scope.

Hence, there is a need in the art for a means to allow users to find non-text-based files or documents stored upon computers making up distributed computer networks. In particular, there is a need to provide a search engine that allows a user to search for numerical data, such as graphs, charts, tables, etc.

According to a first aspect of the present invention there is provided a computer-implemented method for indexing numerical information embedded in one or more electronic files, the method comprising:
a. determining whether an electronic file comprises one or more images containing embedded numerical data, including the steps of;
   a.1 inputting the one or more images into a classification system comprising a plurality of interconnected classifiers; and,
   a.2 classifying the one or more images using the classification system to output data classifying each image as one of: containing embedded numerical data or not containing embedded numerical data.
b. analysing the file to output data classifying it as one of: containing tabulated numerical data or not containing tabulated numerical data; and,
c. if the data outputted above indicates that the file comprises one or more images with embedded numerical data and/or contains tabulated numerical data, extracting text and/or other data associated with the numerical data and indexing this text and/or other data in a database.

According to a particular variation of the present invention step a further comprises:
a.1.1. processing the file to determine one or more image properties; and
a.2.2. inputting one or more of the image properties into each classifier.

According to a second aspect of the present invention there is provided an indexing system for indexing numerical information embedded in one or more electronic files, the system comprising:
a classification system adapted to receive an electronic file and output classification data indicating whether the electronic file comprises one or more images with embedded numerical data and/or tabulated numerical data, the classification system further comprising:
   an image classification system comprising a plurality of interconnected image classifiers that classifies the one or more images in order to output data indicating whether the electronic file comprises one or more images containing embedded numerical data, and
   a table classification system that receives the electronic file as an input and outputs data indicating whether the electronic file contains tabulated numerical data; and

an indexer connectable to a database that receives the classification data and, if the classification data indicates that the electronic file comprises one or more images with embedded numerical data and/or contains tabulated numerical data, extracts text and/or other data associated with the numerical data and indexes said text and/or other data in the database.

According to a third aspect of the present invention there is provided a search system for locating one or more electronic files comprising:
a database populated with data using the indexing system specified above;
an input component to receive search data from a user;
a search component to compare the search data with the index data of the database; and
a display component for displaying to the user the location of any electronic files whose index data matches the search data.

According to a fourth aspect of the present invention a computer program product is provided comprising program code configured to perform the computer-implemented method of first aspect of the invention.

The present invention can thus be used to build an index of files or documents that contain numerical data; for example, these files or documents may be HTML pages that contain embedded images or tables, or may be the embedded images or tables themselves. These files or documents may be distributed across computer systems connected to the Internet, or computer systems connected to an internal organisational network, such as an Ethernet Local Area Network (LAN). Indexing numerical information may comprise indexing relevant text associated with the file or document that contains the numerical information in a database, for example storing the title of an image that is embedded in an HTML tag associated with the image, or storing the title of a table present in the first row of the table.

Embodiments of the present invention will now be described by way of example with reference to the accompanying drawings, in which:

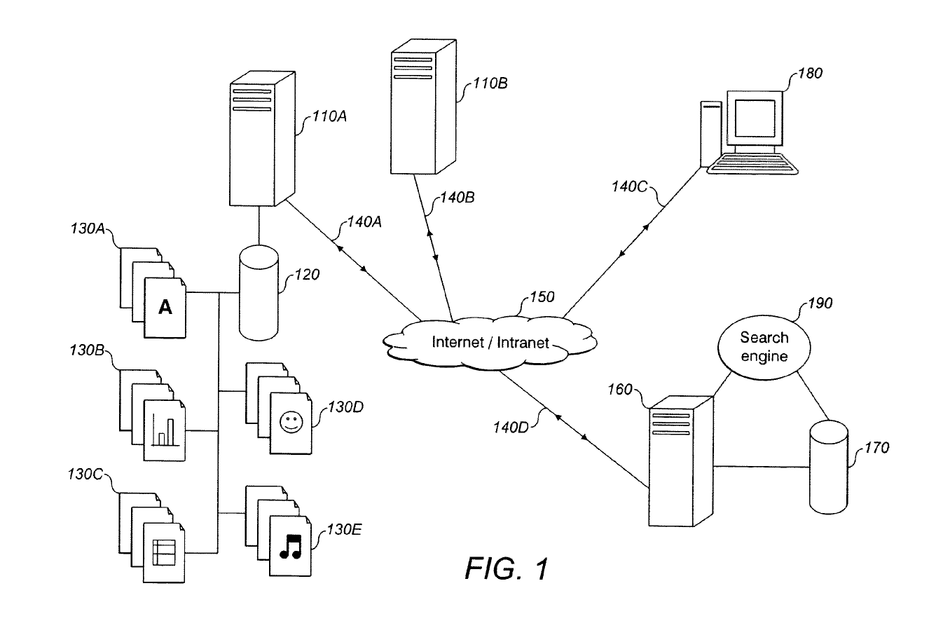

FIG. 1 illustrates schematically a system according to the present invention in the context of an exemplary network arrangement;

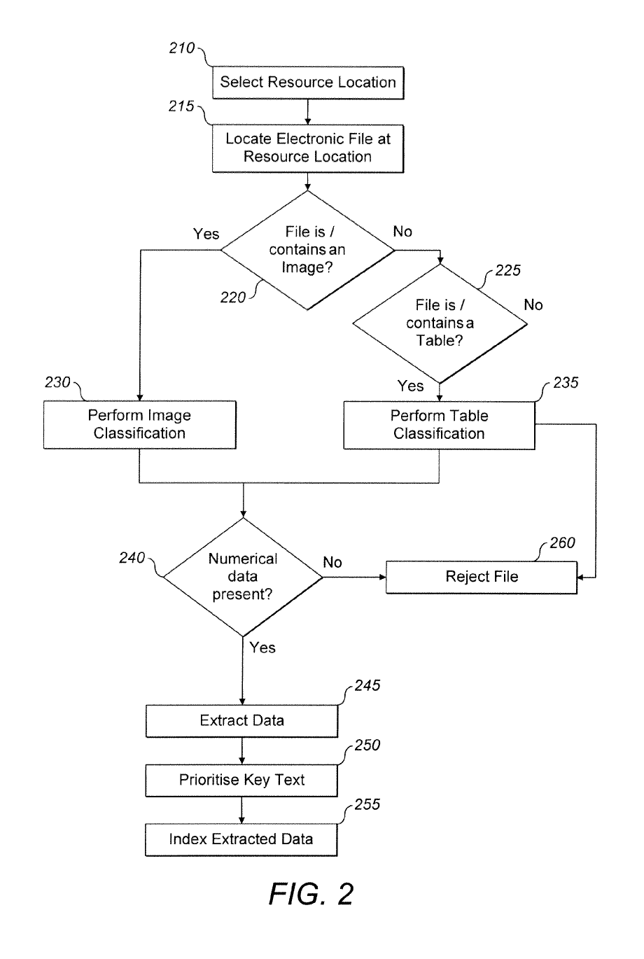

FIG. 2 illustrates a method of indexing numerical data according to the present invention;

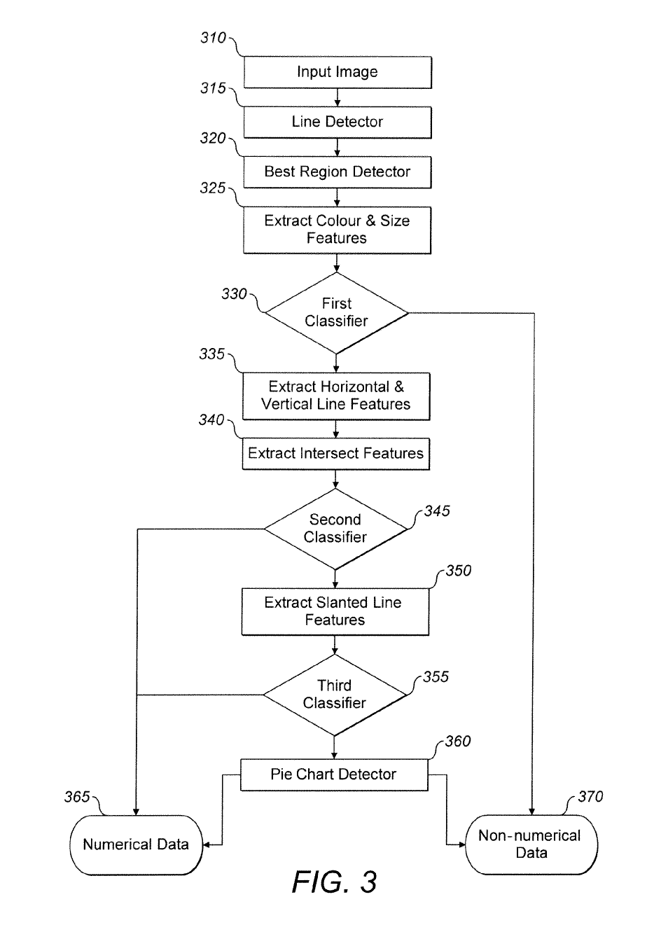

FIG. 3 illustrates a method of identifying embedded numerical data within electronic files or documents according to the present invention;

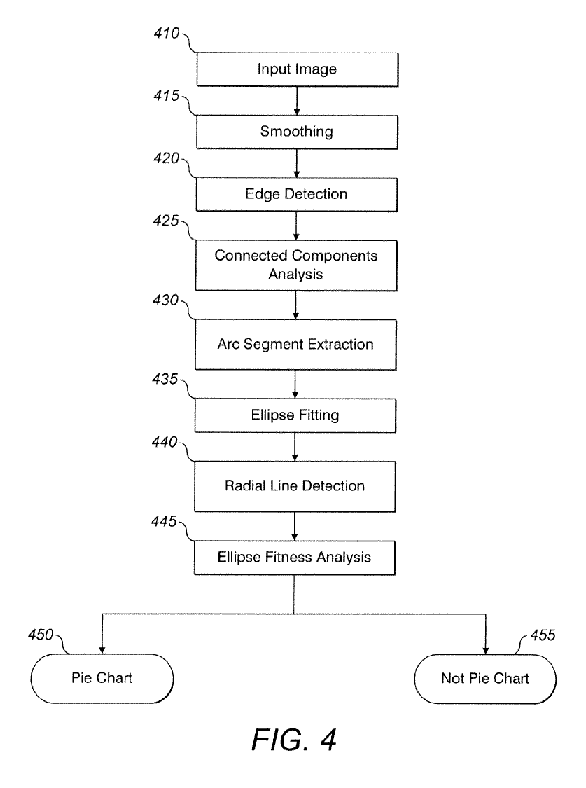

FIG. 4 illustrates a method of determining whether an image is a pie chart according to one embodiment of the present invention;

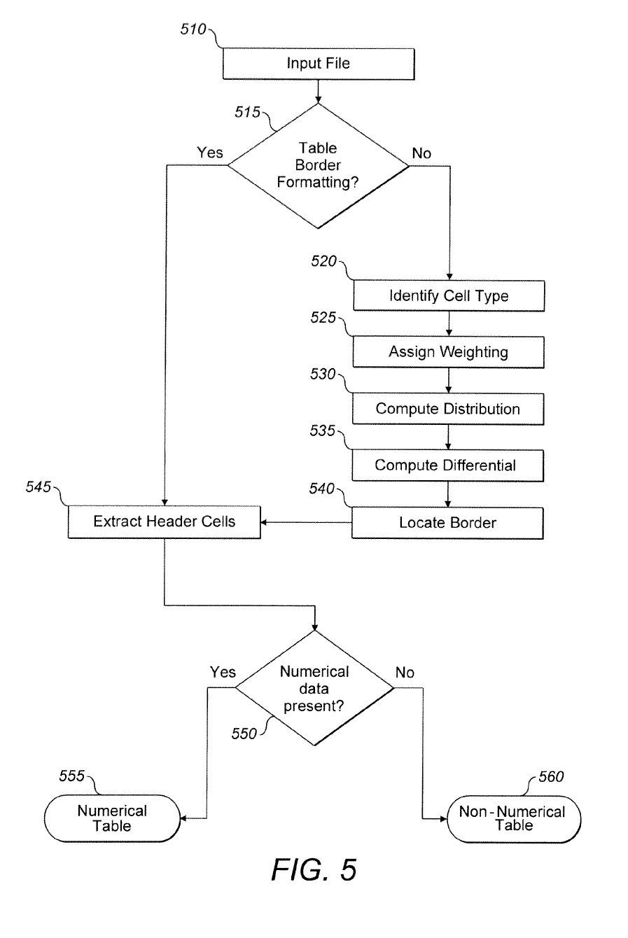

FIG. 5 illustrates a method of determining whether a table comprises numerical data according to one embodiment of the present invention;

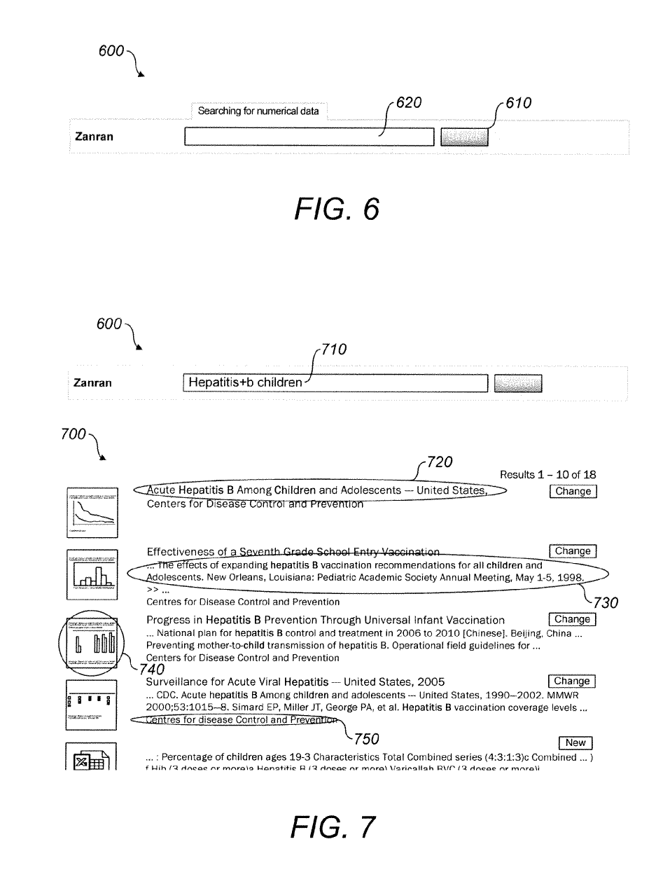

FIG. 6 shows an example user interface for implementing the present invention; and

FIG. 7 shows an exemplary list of results returned by a search engine implemented according to the present invention.

According to a preferred embodiment of the present invention a user is able to locate files and documents containing embedded numerical data that are stored on heterogeneous computer systems connected to a distributed network.

FIG. 1 illustrates a schematic network arrangement for use with the present invention. The arrangement comprises a number of server computers 110A, 110B . . . connected to a network 150 through respective network connections 140A, 140B . . . This network may be any one of a Local Area Network (LAN), a Wide Area Network (WAN), or a mixture of network types, such as the Internet. The network may use a common high-level protocol, such as TCP/IP, and/or may comprise a number of networks utilising different protocols connected together using appropriate gateway systems. The network connections 140 may be wired or wireless and may also be implemented using any known protocol.

Each server may host a number of electronic files or documents that can be accessed across the network. In the present example, server 110A is shown schematically in more detail and comprises a storage device 120 upon which a number of files 130A, 130B . . . are stored. The storage device 120 may be a single device or a collection of devices, such as a RAID (Redundant Array of Independent Disks) array. The server 110A controls access to the files 130A, 130B . . . by implementing protocols known in the art, for example if the server is connected to the Internet the server 110A may resolve requests for files using the GET HTTP (HyperText Transfer Protocol) command.

In FIG. 1, storage device 120 stores five types of files or documents: documents primarily containing text 130A, images primarily containing graphical data 130B, documents primarily containing tables of data 130C, images that do not primarily contain graphical data 130D and multi-media files 130E. Typically, these five document types will be intermixed and the separation shown in FIG. 1 is for illustration only. For example, storage device 120 may store a number of HTML documents or web pages that make up a web site. A web page may comprise differing combinations of content: for example the page may comprise text within a <body> or <p> (paragraph) HTML tag, together with an embedded image file using an <img> HTML tag. Files are typically embedded in an HTML page by including a link to a file's location, wherein the file is then retrieved and embedded into the final displayed page by an Internet browser. Hence, in the present example file 130A may be an HTML file containing appropriate text into which image files 130B or 130D may be then embedded by providing a link in the HTML file to the image files location on storage device 120. Alternatively, storage device 120 may store one or more files in other formats, for example as a PDF (Portable Document Format) file, wherein the PDF standard is a proprietary format used by Adobe Systems Incorporated, i.e. the method and system of the present invention may be applied to PDF files.

Files 130A, 130B . . . may be accessed by a user operating a client computer 180 connected to the network 150 through connection 140C. For most home users and small organisations, this connection will be provided by an Internet Service Provider (ISP). The user may access the files 130A, 130B . . . directly by entering a known URL for the file into a browser. However, in many cases the user will not know the exact URL of the file but will instead be directed to the file by a search engine based on a query containing a number of keywords or phrases that are associated with the file's content and/or embedded content.

A server 160 provides a computer system to implement a search engine 190 that enables a user to locate files 130B and 130C containing numerical data. Server 160 is connected to network 150 through connection 140D. In use, a user accesses a search engine 190 by entering the URL of the search engine into a browser running on client computer 180. The user then enters a search query comprising one or more keywords or phrases that may be optionally linked by one or more logical operators such as “AND”, “OR” and “NOT” into a text-box provided by the search engine 190.

FIG. 6 shows an exemplary search interface 600 comprising a text-box 620 for entering a search query and a “Search” button 610 for sending the search query to the search engine 190. The search engine 190 processes and implements this query upon a database of indexed files 170. The database comprises location information such as URLs for a number of files that have been indexed according to the methods of the present invention, which are described in more detail below. The location information is indexed in the database along with relevant text extracted from the file itself or associated files. The search engine compares the keywords or phrases from the user query with the extracted text stored in the database 170. If a full or partial match is found, the search engine will display to the user various textual and/or image information related to the result of the query.

FIG. 7 shows an exemplary set of results for the query “hepatitis B children” 710. The list of results 700 comprises: some partial sentences where the query keywords are found 730; a link to the original site 720, a link which may comprise a description or title text; a text string indicating the source organisation 750; and a thumbnail of the embedded numerical data 740. This thumbnail image may be expanded to a readable size by hovering the mouse cursor over it.

The method of classifying and indexing numerical data embedded within files located on distributed networks will now be described in relation to FIG. 2. FIG. 2 illustrates a method that may be used as part of an autonomous routine to “crawl” the Internet. Such a routine may be implemented by running program code upon a processor forming part of server 160 or a separate computer system.

At step 210 a resource location, such as a URL, is selected. The search engine may be provided with a list of URLs representing known sources of numerical data, or a URL may be selected by following a link, or a plurality of links, from an initial or “seed” URL. In some embodiments, the URL may be an HTTP or FTP (File Transfer Protocol) address. In other embodiments, the resource location may be a drive path (e.g. “N:\”) pointing to a networked storage device. After a resource location is selected, the routine determines whether there are any electronic files or documents located at that resource location at step 215. For example, if the resource location selected in step 210 is a root HTTP address, the routine may select one of a plurality of files hosted at that address. At step 220 the routine determines whether the file is an image, or contains an image. If the file is determined to be an image, or determined to contain an image, then the method proceeds to steps 230 and 240, wherein image classification is performed upon the file to determine whether the file contains embedded numerical data. A preferred embodiment of this image classification is shown in FIG. 3 and is described in more detail below. If the file is not determined to be an image or to contain an image at step 220, then a check is made at step 225 to see whether the file is, or contains, a table. If this check generates a negative result the file is rejected at step 260. If the file is found to be, or contain, a table then the method proceeds to steps 235 and 240, wherein table classification is performed upon the file to determine whether the file is, or contains, a table comprising numerical data. A preferred embodiment of this table classification is shown in FIG. 5 and is described in more detail below.

If the result of step 240 shows that relevant numerical data is present within the file, for example that the file comprises an image of a graph or is/contains a table with a particular proportion of numeric entries, then the file is retained. If the results of step 225 or 240 show otherwise then the file is rejected at step 260.

Data associated with the file is extracted in step 245. In a preferred embodiment of the present invention the extracted data is ranked, or given a weighting or prioritisation, in step 250. The resulting data is then indexed in database 170 at step 255.

In some embodiments, when the file comprises an image or table embedded in an HTML document, textual information may be extracted from the HTML document. For example, the HTML document may comprise HTML tags associated with the embedded file such as the organisation associated with the root URL (e.g. present in <HEADER> or <META> tags), the title of the HTML document (e.g. Present in <TITLE> tags), the title of the embedded file, (e.g.

from the “title” parameter in the <IMG> tag), alternate text for the embedded file (e.g. from the “alt” parameter in the <IMG> tag) or the anchor text (e.g. text within the anchor or <A> tags) associated with the embedded file or linking to the embedded file. Text may also be taken from near the image. For non-HTML documents, textual information may be extracted from the text surrounding or referring to the embedded file. This textual information may include the text surrounding the embedded file (e.g. above a graph or table) and/or the text pointing to the embedded file via a textual reference or a network link. When the file is or contains a table the text present in header rows or columns may also be extracted.

The objective of the data extraction process is to take as little data as possible, but enough to establish a description of, and the context of, the file containing numerical data.

The text extraction process described in the previous paragraphs outputs a list of text strings associated with an image. One or more of these text strings may be used in the indexing process 255. The index itself may take numerous forms depending on the implementation and priorities of the system. The index may be generated using known indexing techniques and/or may comprise a number of different indexes used in parallel. Normally, common words, such as prepositions or conjunctions (e.g. “the”, “of”, “and” etc), are not added to the index. In a preferred embodiment, the index or indexes are implemented within a database system; however, other methods of implementation could also be used.

The result of the process illustrated in FIG. 2 is an index of a sub-set of the World Wide Web (the collection of files hosted upon the Internet), wherein the sub-set comprises only graphical or numerical material. A generated index will thus contain key text related to this sub-set, together with their URLs. This index may then be searched by a user as part of a search query.

In a preferred embodiment, once an electronic file has been located at a resource location in step 215, the file is downloaded from said location and is saved as part of a local collection of files. Hence steps 220 to 260 are performed on a collection of local files by the server computer 160, which accelerates the classification process. However, it is also possible to perform steps 220 to 260 “in-situ” upon files hosted upon the distributed network, wherein files are processed sequentially during a crawl, each file being temporarily cached for classification before being deleted after the process. The index created may be stored on a storage device that is local or remote to a server, such as 160, performing the processing of FIG. 2.

The image classification performed at step 230 will now be described in more detail according to a preferred embodiment of the present invention. The present invention presents a method of classifying an image to determine whether the image contains numerical data or information; for example, whether the image comprises a bar chart, pie chart, or line graph. To perform this classification a set of features are extracted from the image and these features are then inputted into a previously trained machine-learning algorithm. The machine-learning algorithm is trained in advance using a large set of labelled images and the algorithm may optionally be adapted to optimize the classification process with every image that is classified.

Typically, the features extracted from each image comprise a set of geometric and colour features and the same features are used for both training and classification. To increase accuracy when identifying images that contain numerical data, a preferred embodiment of the present invention extracts a particular sub-set of image features from each image and uses this sub-set to optimise training and classification.

The machine-learning algorithm may utilise any machine learning technique known in the art; for example, one or more of: decision trees, neural networks, support vector machines, clustering, Probabilistic or Bayesian methods and Bayesian networks. The machine-learning algorithm may also make use of known “boosting” or meta-algorithmic techniques, such as Adaboost, that minimise a loss function using multiple classifiers and/or may comprise a number of different techniques operating in a complex system.

FIG. 3 illustrates a preferred embodiment of the image classification routine performed at step 230. In other embodiments certain stages may be omitted and the sequence of events may be altered within the scope of the invention to suit the particular requirements of individual implementations. For example, using all the features above, one could build a separate classifier for each graph type: one classifier to detect pie charts, another classifier to detect bar charts, etc. At step 310 in FIG. 3 an image is input into a main classification algorithm. At step 315 a Hough transform is applied to the image to extract features related to any lines present within the image. The Hough transform is a standard method known in the art and is described in U.S. Pat. No. 3,069,654; the method being further developed by Richard Dudar and Peter Hart in their paper “Use of the Hough Transform to Detect Lines and Curves in Pictures”, Comm. ACM, Vol. 15, pp. 11-15 (January, 1972). The Hough transform generates data corresponding to lines within the image and this data is further processed to produce data related to one or more of the following line types: vertical, horizontal, almost vertical, almost horizontal and other. At step 315 the number of lines of each orientation may be counted and parameters relating to the position of each line may also be recorded. In a preferred embodiment of the present invention the output of this stage comprises:

TABLE 1

| Feature | Description |
|---|---|
| hor_start | Number of horizontal/vertical lines as |
| vert_start′ | output by Hough Line detector |
| almost_hor_start | Number of almost (within a few degrees) |
| almost_vert_start | horizontal/vertical lines as |
| | output by Hough Line detector |
| other_start | Number of all other remaining lines |

The Best Region Detection 320 stage comprises applying a Best Region Detection algorithm to the image to detect an optimal area of the image on which to perform classification. For example, often in images of bar charts, line charts and tables, the image of the chart or table does not fill the entire image space within the file. In these cases, the area surrounding the valid graph or table may interfere with the classification process. For example, menus, borders, frames, text, titles and other material that is not directly part of a chart or table may lead to misclassification. It is therefore important to extract the area that is most likely to be of interest. As bar charts and line charts are often bounded by X-Y axes and tables are often bounded by borders, the Best Region Detector attempts to detect these boundaries and extract the image data within for use in classification.

The Best Region Detector begins by receiving data related to detected horizontal and vertical lines that has been output by the Hough line detector. From this data, the Best Region Detector computes the areas of all rectangular boxes or segments partially bounded by the intersection of one horizontal line and one vertical line; i.e. evaluates all rectangular areas surrounded by two or more intersecting lines. The intersecting lines surrounding the rectangular segments may also be optionally checked to ensure that they are genuine lines using similar methods to step 335 described below. Rectangular segments that comprise a given area of the image below a predetermined threshold are then discarded at this stage, together with any rectangular segments whose height-to-width ratio falls below a predetermined minimum. The remaining rectangular segments are then sorted by area to form a list of “best” or optimal region candidates for classification, the list being headed by the rectangular segment with the largest area. The Best Region Detector then runs through the listed rectangular segments in order of area and eliminates all segments that contain a horizontal or vertical line that is already used in a rectangular segment with a larger area. If more than one rectangular segment remains after this sorting process then the “best” or optimal region for analysis is selected based on a predetermined heuristic. This heuristic may comprise comparing a number of properties of each segment; these properties comprising the area of each rectangular segment, wherein larger areas may be preferred. These properties comprise also the type of lines making up the rectangle borders and can be either normal lines or lines with ticks, or the sides of a bar, or the lines supporting multiple bars. Each of these line types is given a weighting; for example, lines with ‘ticks’ are given a heavier weight as they often indicate the presence of an axis. These properties also comprise an additional weighting associated to the position and degree of nesting of each rectangular area on the page.

After step 320, the algorithm or method moves to step 325 wherein colour and size features related to the image are extracted. Colour features are especially useful to differentiate natural photos from artificial images. In a preferred embodiment, the image is converted to HSV (Hue, Saturation, Value), colour space and the five most prevalent colours within the converted image are determined, together with the proportion of image pixels belonging to each of the five colours. In other embodiments, a different colour space may be used and the number of prevalent colours may be restricted or extended. In a preferred embodiment, the total number of colours in the converted image and the number of colours with pixel coverage greater than 1% of the total image space are computed. A measure of the colour distribution within the image is then determined by calculating a “colour distance” between two neighbouring pixels. For two given neighbouring pixels within the image, the “colour distance” is calculated as the absolute value of the difference of their RGB (Red, Green, Blue) components. Based on the “colour distance” measurements of neighbouring pixels a number of metrics are calculated for use in the classification process. These metrics may include one or more of: the fraction of pixels with a “colour distance” bigger than zero (F₀), the fraction of pixels with a “colour distance” bigger than a defined threshold (F_{T}) and a ratio of the two fractions. (F₀/F_{T}). In a preferred embodiment the result of step 325 is a feature set comprising:

TABLE 2

| Feature | Description |
|---|---|
| Colors | Total number of colours in the |
| | converted image |
| ColorsBiggerThan | Number of colours with pixel |
| | coverage greater than 1% of the total |
| | image space |
| ColorX(%) | The proportion of image pixels |
| | belonging to each of the X most |
| | prominent colours (in this example |
| | X = {1, 2, 3, 4, 5}) |
| F₀ | The fraction of pixels with a |
| F_{T} | “colour distance” bigger than |
| | zero (0) or a threshold (T) |
| F₀/F_{T} | Ratio of ‘F₀’ over ‘F_{T}’ |
| Size | Number of bytes of image file |
| Width | Width/Height of image in pixels |
| Height | |

After step 325 a first classification is performed on the image using various features extracted in one or more of the previous stages. The first classifier, shown in FIG. 3 at step 330, uses one or more of the features extracted from the Hough Line Detector at step 315 and the colour and size features (file size in bytes) to classify the image as one of a “natural image” (e.g. a photograph) or an “artificial image” (e.g. a graph or a diagram). If the image is classified as a “natural” image it is classified as non-numerical at step 370. If the image is classified as “artificial” then the method proceeds to step 335.

At step 335 a number of features are extracted relating to the horizontal and vertical lines detected in step 315. Each horizontal and vertical line output by the Hough Line Detector is analysed to establish whether the line is: a false positive, for example a “detected” line that is not a genuine line within the image; the side of a bar or other closed area, for example this may be a line separating two different colour areas forming the bars of a bar chart; a line with “ticks”, i.e. a line with smaller line segments extending perpendicularly from the line at regular intervals; a dashed or broken line; a line at a base of multiple bars or closed areas, for example, a line at a base of a bar chart; or a normal or standard line, for example, a line separating two areas of the same colour.

In order to perform the analysis of step 335, a number of pixels forming an area encompassing each detected line are extracted and a black and white conversion algorithm is applied to the extracted pixels. The extracted pixels will typically comprise a box of pixels of height “x” and width “y”, wherein the box contains pixels that comprise the detected line. In a preferred embodiment the black and white conversion algorithm is based on an Otsu algorithm, which optimally selects a grey level threshold for the conversion. Additionally the conversion algorithm may be further adapted to determine whether the black and white pixel allocation needs to be reversed to best represent the original image.

To determine the type of line that has been detected, the number of black pixels is computed for each row of pixels in the extracted area and the differential of black pixels from one row to the next is computed. The largest differential jump is identified and the rows associated with this maximum are labelled as the rows with the most or fewest black pixels, respectively. A third row in the proximity of the row with most black pixels but not on the same side as the row with the fewest black pixels is also identified. The percentage of black pixels within each of the three identified rows is also computed. Lines that have too small a differential from one row to another are considered false positives and eliminated. A small differential across the rows with most or fewest black pixels may additionally signify the presence of a dashed line. Therefore, the algorithm determines whether the line comprises a dashed line by analysing the sequence of black and white pixels along the row of pixels with most black pixels. In this analysis, the number of consecutive black and white pixels along the line is computed as a list of integers. The pattern and repetitive nature of that sequence of integers is then further analysed by computing the frequency and coverage of the most common digit or subset(s) of digits in the sequence of integers and criteria are applied to validate or invalidate a line as an interrupted or dashed line.

Similarly, the presence or absence of ticks (i.e. short line segments extending perpendicularly from a line) is also established by analysing the pattern of consecutive black and white pixels computed as a sequence of integers. Each side of a selected line is then analysed for the presence of one or more bars (i.e. rectangular areas extending perpendicularly from the line). The presence of a bar is characterised by the presence of a cluster of consecutive black pixels separated by white pixels repeated over a plurality of rows of pixels. The pattern of the sequence of black and white pixels is analysed, the number of bars, their widths and coverage is established and the criteria are used to validate or invalidate the presence of such bars.

In a preferred embodiment, step 335 produces a feature vector comprising the following features:

TABLE 3

| Feature | Description |
|---|---|
| hor_multibar_tick | Number of horizontal/vertical lines |
| vert_multibar_tick | with ‘ticks’ supporting multiple bars |
| hor_multibar | Number of horizontal/vertical lines |
| vert_multibar | supporting multiple bars |
| hor_tick | Number of horizontal/vertical lines |
| vert_tick | with ‘ticks’ |
| hor_boxe | Number of horizontal/vertical sides of |
| vert_boxe | a bar |
| hor | Number of horizontal/vertical/slanted |
| vert | lines |
| other | |

After step 335, the method continues to step 340, wherein intersect features related to the detected lines are also extracted from the image. At this stage, the horizontal and vertical lines detected by the Hough Line Detector at step 315 are analysed to compute the largest number of lines intersecting with a single horizontal line and/or a single vertical line. This then produces the following feature vector:

TABLE 4

| Feature | Description |
|---|---|
| MostIntersectWithHor | Largest number of lines intersecting |
| MostIntersectWithVert | with any horizontal/vertical line |

At step 345 a number of the extracted features from previous analysis of the image (described above) are fed into a second classifier that is adapted to classify the image as one of “graph/table”, i.e. containing numerical data, or “other”. Images classified as “graph/table” are labelled as containing numerical data at step 365. The second classifier is adapted to use one or more of the following extracted features: the Hough lines features extracted at step 315; the colour and size features extracted at step 325; the axes and best region features extracted at step 320; the horizontal and vertical line features extracted at step 335; and the intersecting features extracted at step 340.

If the image is classified as “other” the method proceeds to step 350, wherein the analysis performed at step 335 is repeated for lines orientated at an angle (“slanted” lines that are neither vertical nor horizontal) that were output by the Hough Line Detector. In a preferred embodiment this step thus produces a feature vector as below:

TABLE 5

| Feature | Description |
|---|---|
| slanted_multibar_tick | Number of slanted lines with ‘ticks’ |
| | supporting multiple bars |
| slanted_multibar | Number of slanted lines |
| | supporting multiple bars |
| slanted_tick | Number of slanted lines with ‘ticks’ |
| slanted_box | Number of slanted lines along the |
| | side of a bar |
| hor | Number of |
| vert | horizontal/vertical/slanted |
| other | lines |

After step 350 the method applies a third classifier at step 355. This classifier is similar to the second classifier and classifies the image as one of a “graph/table”, i.e. containing numerical data, or “other”. The third classifier uses one or more of the features used by the second classifier and additionally uses the “slanted” line features extracted at 350. If the third classifier classifies the image as a “graph/table” at step 355, then the image is labelled as numerical data at step 365. If the image is classified as “other” the method then proceeds to step 360, wherein an algorithm is run upon the image to detect the presence of a pie chart.

The detection of pie charts at step 360 requires the detection of circles and ellipses in an image. In a preferred embodiment of the invention, shown in FIG. 4, the image is input into the algorithm at step 410. The image is then smoothed at step 415 and an edge detection algorithm is run upon the image at step 420 to produce an edge image. The edge detection algorithm may be any edge algorithm known in the art; however, in a preferred embodiment a “Canny” edge detection algorithm is used, as described by John F Kenning in “A Computational Approach to Edge Detection”, IEEE Trans. Pattern Analysis and Machine Intelligence, 8:679-714, 1986.

After an edge image has been produced a connected components analysis is performed at step 425 on the edge image to produce a set of “contours” that are made up of connected pixels. The connected components analysis may comprise that described by Haralick, Robert M., and Linda G. Shapiro, in Computer and Robot Vision, Volume I, Addison-Wesley, 1992, pp. 28-48.

Following this analysis an arc segment extraction routine is performed at step 430. All points on a selected contour are processed and each contour is broken into a number of smaller segments by looking for changes of direction along the contour that exceed a predetermined threshold. The change of direction metric that is to be compared with the predetermined threshold is computed using a number of pixels that are separated along the contour by a set number of pixels, rather than being calculated using consecutive pixels along the contour, as using separated pixels makes the detection more robust. After this separation process the algorithm produces a number of separated arc segments that are smoother than those originally detected using the connected component analysis.

The pie chart detection algorithm then proceeds to extend isolated arc segments by adding a tangent to each segment at each end of the arc. After these tangents have been added then an arc binding process is started, wherein multiple arcs are compared and, if two tangents that extend from different arcs cross with an angle below a predetermined threshold, it is determined that the two arcs can be bound together to form a group arc segment. The process is then repeated for these bound arcs with qualification. For example, if arc segments A and B are bound together in the previous manner and is found that arc segments B and C are also to be bound together then the three arc segments A, B and C are bound together in a single group. However, if A and C are not suitable to be bound together, for example, if the extension to arc C crosses the extension to arc A with an almost identical angle, a mechanism is put in place to connect arc segments A and C by an intermediary arc segment. If a tangent extending from the end of an arc segment is found to cross more than one other tangent connected to more than one corresponding arc, the algorithm selects the two arcs that produce a tangent intersection that is closest to both arcs. This means that only one extension to each arc segment is allowed. The connected arc segments are then recombined into bound single-arc segments.

An ellipse fitting algorithm is then applied at step 435 to each regrouped single-arc segment, starting with the longest arc segment. The ellipse fitting algorithm may be iterated a number of times to better fit a model ellipse with the generated arc segments. The algorithm may also fit one or more modelled ellipses to one or more potential “ellipses”.

After an ellipse has been fitted to any arcs present in the image the algorithm then detects and counts a number of area segments present within the proposed model ellipse. These area segments are delimited by examining the lines crossing the model ellipse at step 440. This is performed by examining the lines detected by the Hough Line Detector at step 315 to see whether any of them have a centre point that falls within the model ellipse. A check is then made as to whether the distance between the line and the centre of the model ellipse falls within a predetermined threshold. If one or more lines are separated by a distance that falls below a further predetermined threshold, one or more of these lines are deleted to avoid double counting lines that are next to each other. The angle each remaining line makes with the edge of the model ellipse is then calculated, and the number of area segments within the ellipse is then determined based on these calculations.

At step 445 an Ellipse Fitness Analysis is performed. This generates a fitness measure documenting the fit of the model ellipse. Using this value and optionally one or more outputs of the previous stages, a classification metric is computed which is then compared with a predetermined threshold; the result of this comparison determining whether a pie chart is present or not. If a pie chart is present at step 450 then the image is labelled as numerical data in step 365. If a pie chart is found not to be present at step 455 then the image is labelled as non-numerical data at step 370.

The preferred embodiment of the present invention shown in FIG. 3 uses three classifiers and a pie chart detector to determine whether an image contains numerical data. In other embodiments of the present invention one or more of steps 315, 320, 325, 335, 340 and 350 may be used to generate features that may be fed into a classifier in order to determine whether the image comprises numerical data or non-numerical data. For example, the image classification shown in step 230 of FIG. 2 could alternatively comprise steps 310, 315, 335 and 345 whilst omitting other steps. As is evident to one skilled in the art, the more features that are included in the classification, the more accurate the classification may be. In the preferred embodiment of the present invention multiple classifiers are used which increases performance.

In the embodiments shown in FIG. 3, the first to third classifiers 330, 345 and 355 are trained using a large sample set of images, wherein each image in the sample set is labelled with a particular class, for example “natural” or “artificial”. Using this training data, each of the classifiers is optimised to produce the best classification for the data. The optimised classifiers can then be applied to a real environment to classify unknown and unseen images. Tests performed on unseen data using the preferred embodiment of the present invention produced a false-positive percentage of around 1%, wherein a false-positive classification comprises an image that has been wrongly classified as a numerical image when it is in fact a non-numerical image, and a false-negative percentage of around 15%, wherein a false negative classification comprises wrongly classifying a numerical image as a non-numerical image. These figures compare favourably to image classification in other fields.

The table classification performed in step 235 will now be described in accordance with a preferred embodiment of the present invention shown in FIG. 5. This classification analyses tables stored across a distributed network that are in HTML, Microsoft Excel or another format. It classifies those tables whose content is primarily numerical from those content is primarily non-numerical and which are using a table structure to present textual or other non-numerical information.

The classification algorithm begins by receiving the file to analyse at step 510. At step 515 the file is analysed to determine whether there are any formatting tags present within the file or document, i.e. does the file have table border formatting information? For example, if the document is an HTML document, then HTML tags are processed to identify the table borders. If no such boundary formatting information is available, for example as is found with Excel files, the classification algorithm finds ‘transitions’ in the rows and columns which indicate the boundaries of each table. The transitions are the line of change from primarily text content to primarily numerical content or to primarily no content (empty rows/columns). The preferred method of finding transitions is given in the following paragraphs.

Transitions are computed as follows. A simple function 520 decides whether each cell within the document contains numerical data, text data or no information (“other”). For example, there are known routines that analyse character strings to determine whether the string contains numerical data. Text formatted cells are converted to number formatted cells if the text contains only numerical information. A weighting is assigned to each cell at step 525, wherein a fixed weighting is associated to each numerical cell and a different weighting of opposite sign is associated to each textual cell.

At step 530 the distribution of numerical and textual cells is calculated along the sets of rows and/or columns. A distribution parameter is calculated by summing the weighting of each cell for each row and each column. As an example, a row with many textual headers may have a large negative summation value indicating a large amount of textual information, whereas a row containing numerical data may have a large positive summation value. A differential function is then computed for each row and/or column at step 535 based on the values of the parameter in a few rows preceding the current row and/or column. For instance, the differential function may be a simple function subtracting the parameter value in the preceding row or column from the value in the current row or column. Minima and maxima in the differential functions are used to locate the transition boundaries between textual headers and numerical information at step 540 and also allow the end of the table to be computed.

For tables classified as numerical, row and column headers for the data are identified at step 545. For example, the number of column headers to be added beyond the text/data transition is computed by checking for the presence of any textual cell above the transition row. When looking for transition columns, columns to the left and/or right of the transition column are analysed. The result of this analysis is a table area wherein the header cells have been located.

When the table borders are defined and the headers cells have been extracted, a classification is made at step 550. A table is classified as containing numerical information at step 555 if the number of numerical cells exceeds a predetermined threshold and/or there exists a percentage of numerical cells above a predetermined value. If the result of the classification finds otherwise the table is labelled as a non-numerical table in step 560.

In an optional variation of the present invention, the search engine 190 is further adapted to intelligently select the description and/or title text that is returned to a user after a search. The process described in the next paragraph selects the best description or title from amongst the text strings stored in association with the graph/table at step 245 in FIG. 2.

Initially, a training set of images and/or tables is taken and the strings that best describe each image and/or table are manually selected from amongst the various text strings available for that image and/or table. A machine learning algorithm using any of the techniques described above is then trained using the data which results in an algorithm for selecting description text. Subsequently this resulting algorithm is applied to the text strings associated with other images and/or tables in step 250.

1. A computer-implemented method for indexing numerical information embedded in one or more electronic files, the method comprising:
a. determining whether an electronic file comprises one or more images containing embedded numerical data, including the steps of;
a. 1 inputting the one or more images into a classification system comprising a plurality of interconnected classifiers; and,
a.2 classifying the one or more images using the classification system to output data classifying each image as one of: containing embedded numerical data or not containing embedded numerical data.
b. analysing the file to output data classifying it as one of: containing tabulated numerical data or not containing tabulated numerical data; and,
c. if the data outputted above indicates that the file comprises one or more images with embedded numerical data and/or contains tabulated numerical data, extracting text and/or other data associated with the numerical data and indexing this text and/or other data in a database.

2. The computer-implemented method of claim 1, wherein step c. further comprises storing the location of the electronic file with the index data.

3. The computer-implemented method of claim 1, further comprising:
a. receiving search data from a user;
b. comparing the search data with the index data of the database; and
c. displaying to the user the location of any electronic files whose index data matches the search data.

4. The computer-implemented method of claim 3, further comprising:
d. displaying to the user descriptions of the electronic files

5. The computer-implemented method of claim 1, wherein one or more of the electronic files are stored on a remote computer.

6. The computer-implemented method of claim 5, wherein one or more of the electronic files are accessed at a universal resource locator address.

7. The computer-implemented method of claim 1, wherein the extracted data comprises one or more of:
a title associated with the one or more images containing embedded numerical data and/or associated with the tabulated numerical data;
an organisation associated with the one or more images containing embedded numerical data and/or associated with the tabulated numerical data;
a header associated with the one or more images containing embedded numerical data and/or associated with the tabulated numerical data;
alternate text associated with the one or more images containing embedded numerical data and/or associated with the tabulated numerical data;
anchor text associated with the one or more images containing embedded numerical data and/or associated with the tabulated numerical data;
text surrounding the one or more images containing embedded numerical data and/or the tabulated numerical data; and
text referring to the one or more images containing embedded numerical data and/or the tabulated numerical data.

8. The computer-implemented method of claim 1, wherein step a. further comprises:
a.1.1 processing the file to determine if it comprises one or more images;
a.1.2 if the file does comprise one or more images, for each image, determining image properties; and
a.2.2 inputting one or more of the image properties into each classifier.

9. The computer-implemented method of claim 8, wherein step a. comprises:
a. 1. determining whether each image contains one or more lines; and
a.2. if so, processing each image to extract line data corresponding to one or more pre-defined graphical properties particular to embedded numerical data in graphical form, said line data forming one of the one or more image properties.

10. The computer-implemented method of claim 9, further comprising:
a.1.1. using a Hough line detection algorithm to determine whether each image contains one or more lines;
a.2.2 processing each image using data output by the Hough line detection algorithm to extract the line data.

11. The computer-implemented method of claim 10, wherein the data output by the Hough line detection algorithm forms one of the one or more image properties.

12. The computer-implemented method of claim 9, wherein the one or more lines comprise one or more of vertical, horizontal and slanted lines.

13. The computer-implemented method of claim 9, wherein step a.2. comprises:
determining whether a detected line comprises one or more of: a line separating two different colour areas, a line forming the base of a number of rectangular sections, or a line comprising one or more perpendicular markings.

14. The computer-implemented method of claim 9, further comprising the step of:
a.3 using the extracted line data to determine if each image contains one or more rectangular areas bounded by two or more intersecting lines;
a.4 examining the extracted line data of the one or more areas to select a region of each image that is most likely to correspond to a region containing embedded numerical data in graphical form; and,
a.5 generating region data corresponding to the selected region, said region data forming one of the one or more properties of each image.

15. The computer-implemented method of claim 8, wherein step a. further comprises:
determining the number of colours used in each image and using this data as one of the one or more image properties.

16. The computer-implemented method of claim 8, wherein step a. further comprises:
generating a measure of the colour distribution within each image and using this data as one of the one or more image properties.

17. The computer-implemented method of claim 8, wherein step a. comprises:
determining whether each image contains an ellipse and using this determination as one of the one or more image properties.

18. The computer-implemented method of claim 17, wherein the step of determining whether the image contains an ellipse further comprises:
performing edge detection upon each image;
performing a connected components analysis on the filtered image;
splitting each connected component into a number of arc segments;
binding the arc segments to form one or more arc groups;
applying an ellipse fitting algorithm to each arc group to identify the presence of an ellipse that best fits the image data; and,
using data corresponding to the identified ellipse as one of the one or more image properties.

19. The computer-implemented method of claim 17, further comprising:
using the extracted line data to determine whether an identified ellipse comprises one or more interior segments; and,
using the number of detected interior segments as one of the one or more image properties.

20. The computer-implemented method of claim 8, wherein:
step a. comprises:
determining a plurality of image properties;
step b. comprises:
b.1. splitting the plurality of image properties of each image into a plurality of subsets of image properties;
b.2. inputting each subset into a selected one of the plurality of interconnected classifiers; and,
step c. comprises:
c. 1. integrating the output of the plurality of classifiers to output data classifying the image as one of: containing embedded numerical data or not containing embedded numerical data.

21. An indexing system for indexing numerical information embedded in one or more electronic files, the system comprising:
a classification system adapted to receive an electronic file and output classification data indicating whether the electronic file comprises one or more images with embedded numerical data and/or tabulated numerical data, the classification system further comprising:
an image classification system comprising a plurality of interconnected image classifiers that classifies the one or more images in order to output data indicating whether the electronic file comprises one or more images containing embedded numerical data, and
a table classification system that receives the electronic file as an input and outputs data indicating whether the electronic file contains tabulated numerical data; and
an indexer connectable to a database that receives the classification data and, if the classification data indicates that the electronic file comprises one or more images with embedded numerical data and/or contains tabulated numerical data, extracts text and/or other data associated with the numerical data and indexes the text and/or other data in the database.

22. The indexing system of claim 21, wherein the indexer is adapted to store the location of the electronic file in the database with the index data.

23. The indexing system of claim 21, wherein one or more of the one or more electronic files are stored on a remote computer.

24. The indexing system of claim 23, wherein one or more of the one or more electronic files are accessed at a universal resource locator address.

25. The indexing system of claim 21, wherein the extracted text and/or other data comprises one or more of:
a title, organisation or header associated with the one or more images containing embedded numerical data and/or associated with the tabulated numerical data;
alternate text or anchor text associated with the one or more images containing embedded numerical data and/or associated with the tabulated numerical data; and,
text surrounding or referring to the one or more images containing embedded numerical data and/or the tabulated numerical data.

26. A computer program product comprising program code adapted to perform the computer-implemented method of:
a. determining whether an electronic file comprises one or more images containing embedded numerical data, including the steps of
a.1 inputting the one or more images into a classification system comprising a plurality of interconnected classifiers; and,
a.2 classifying the one or more images using the classification system to output data classifying each image as one of: containing embedded numerical data or not containing embedded numerical data.
b. analysing the file to output data classifying it as one of: containing tabulated numerical data or not containing tabulated numerical data and,
c. if the data outputted above indicates that the file comprises one or more images with embedded numerical data and/or contains tabulated numerical data, extracting text and/or other data associated with the numerical data and indexing this text and/or other data in a database.

27. A search system for locating one or more electronic files comprising:
a database populated with data using an indexing system comprising:
a classification system adapted to receive an electronic file and output classification data indicating whether the electronic file comprises one or more images with embedded numerical data and/or tabulated numerical data, the classification system further comprising:
an image classification system comprising a plurality of interconnected image classifiers that classifies the one or more images in order to output data indicating whether the electronic file comprises one or more images containing embedded numerical data, and
a table classification system that receives the electronic file as an input and outputs data indicating whether the electronic file contains tabulated numerical data and
an indexer connectable to a database that receives the classification data and, if the classification data indicates that the electronic file comprises one or more images with embedded numerical data and/or contains tabulated numerical data, extracts text and/or other data associated with the numerical data and indexes the text and/or other data in the database.
an input component to receive search data from a user;
a search component to compare the search data with the index data of the database; and
a display component for displaying to the user the location of any electronic files whose index data matches the search data.

28. The search system of claim 27, wherein the display component is further adapted to display to the user descriptions of the electronic files.
